(19) United States
(12) Patent Application Publication
(10) Pub. No.: US 2017/0076604 A1
(43) Pub. Date: Mar. 16, 2017

(54) SYSTEM OF BROADCASTING NODES AND RELATED METHOD OF COMMUNICATION

(71) Applicant: Robert Jenkins, Huntington, WV (US)

(72) Inventor: Robert Jenkins, Huntington, WV (US)

(21) Appl. No.: 15/254,677

(22) Filed: Sep. 1, 2016

Related U.S. Application Data
(60) Provisional application No. 62/212,774, filed on Sep. 1, 2015.

(51) Int. Cl. G08G 1/16; H04W 12/04; H04L 29/08

(52) U.S. Cl. CPC G08G 1/161; H04L 67/12; H04W 12/04

(57) ABSTRACT

A system of nodes may communicate a signal between nodes in a manner that prevents looping the same signal through the same node. When a node receives a signal, it may evaluate whether the signal itself includes an identifier of the receiving node, indicating whether or not the receiving node has previously broadcast the signal. The receiving node may have an internal memory with a record of previously broadcast signals, against which it may compare a received signal to determine if the received signal is one that has been previously broadcast. If the signal has previously been broadcast, then the receiving node may discard the signal. If the signal has not previously been broadcast, then the receiving node may add its own unique identifier to the signal and rebroadcast the signal. The internal memory of the receiving node may also be updated to reflect the broadcast.

This application claims priority to U.S. Provisional Patent Application Ser. No. 62/212,774, filed Sep. 1, 2015.

### TECHNICAL FIELD

This disclosure generally relates to a system of devices for communicating with one another for the purpose of enhancing road safety and a related method for said communication.

### BACKGROUND OF THE INVENTION

Certain road conditions may create inconvenient or even hazardous situations, especially if a driver is unaware of said road conditions. For example, a stopped vehicle, such as a school bus or a stalled or wrecked automobile, may be present at a location on a road that is not visible to oncoming traffic. This may be the case in the event of a blind curve, a rolling hill, or any other road location which exists in a location in which an oncoming driver's line of sight to said location is blocked. Without a driver having warning of the road condition at the location that cannot easily be seen, accidents may occur that could otherwise be avoided if the driver had proper warning. Accordingly, a need has been identified for a means to provide sufficient notification to a driver of a vehicle approaching such an inconvenient or hazardous road condition that cannot be seen.

### SUMMARY OF THE INVENTION

An embodiment of the present invention relates to a method for wirelessly propagating a signal. The method may include the step of broadcasting a signal packet from a first node, the signal packet including a first signal value indicating an identity of the first node. A further step of the method includes receiving the signal packet including the first signal value in a second node, the second node being within wireless range of the first node. The second node may authenticate the signal packet. If authenticated, the second node may broadcast the signal packet

The authenticating step may comprise determining if the second node has previously broadcast the signal packet. This may be accomplished by evaluating whether the signal packet itself includes a record of the second node having previously broadcast the signal packet and/or evaluating whether an internal memory of the second node includes a record of previously broadcasting the signal packet.

With respect to the aspect of evaluation of the signal packet itself, in one aspect, the method may include the step of adding a signal value indicating an identity of the broadcasting node to the signal packet prior to broadcasting the signal packet from the broadcasting node. In this embodiment of the method of the current invention, the second node may add a second signal value indicating the identity of the second node prior to broadcasting the signal packet. In the event that the first node receives the signal packet that has been broadcast from the second node, which then includes the first value and the second value, the presence of the first value indicates to the first node that it has previously broadcast said signal packet. Accordingly, the first node may discard the received signal packet with the first value rather than rebroadcasting it.

With respect to the evaluation of the internal memory of the node which receives a signal packet, the receiving node may receive a signal packet, and then compare the received signal packet to a record within the internal memory of the receiving node which of signal packets previously broadcast from the receiving node. If the internal memory includes a record of having previously broadcast the signal packet, then the receiving node may discard the signal packet rather than rebroadcasting it.

The present invention contemplates utilizing either the evaluation of the packet itself, the evaluation of the internal memory of the receiving node, or both, in order to authenticate whether or not a receiving node has previously broadcast a signal packet received by the receiving node.

In a further aspect, the method may include the step of receiving the signal packet in a third node, the third node being within the wireless range of the second node, but not within wireless range of the first node. The third node, like the second node, may be capable of evaluating the signal packet itself and/or an internal memory of the third node for a record of the third node having previously broadcast the signal packet.

The authenticating step of the present invention may include utilizing an encryption key to determine whether the signal packet is received from a trusted source.

The method may further include the step of triggering an output in response to the authenticating of the signal packet in the second node.

In a further embodiment of the present invention, a system of nodes is adapted for communicating at least one signal packet therebetween. The system may include a first node including a first controller in communication with a first internal memory and a first transceiver. The first transceiver may be adapted to receive the signal packet at the first node. The first controller may be adapted to authenticate the signal packet, including evaluating whether the signal packet includes a first value identifying the first node, thereby indicating that the first node has previously broadcast the signal packet. If the first controller determines that the signal packet does not include the first value identifying the first node, the first controller is further adapted to add the first value identifying the first node to the signal packet and to broadcast the signal packet including the first value via the first transceiver.

In one aspect, the first controller is further adapted to authenticate the signal packet by comparing the signal packet to a list within the first internal memory of recent broadcasts emitted from the first transceiver in order to determine if the first node has previously broadcast the signal packet.

In another aspect, the system may further include a second node including a second controller and a second transceiver. The second transceiver may be adapted to receive the signal packet including the first value, from the first node. The second controller may be adapted to authenticate the signal packet including the first value, including evaluating whether the signal packet including the first value also includes a second value identifying the second node, thereby indicating that the second node has previously broadcast the signal packet. If the second controller determines that the signal packet including the first value does not include the second value identifying the second node, the second controller may be further adapted to add the second value identifying the second node to the signal packet and to broadcast the signal packet including the first value and the second value via the second transceiver.

A further embodiment of the present invention relates to a method of signaling a condition requiring caution on a road. The method includes providing a first node associated with a first vehicle, said first node adapted to broadcast a signal in response to the condition. In addition, a second node may be provided, wherein the second node is adapted to receive the signal from the first node. Additionally, a warning indicator may be triggered in a notification device in response to the second node receiving the signal from the first node.

In one aspect, the first vehicle may be a bus, and the condition requiring caution may comprise loading and/or unloading of passengers from the bus. The notification device may comprise a warning light associated with the second node, and the warning indicator may comprise a flashing light.

In a further aspect, the second node may be associated with a second vehicle. The warning indicator may comprise an audio, visual, or audiovisual signal to a driver of the second vehicle relating to the condition.

### BRIEF DESCRIPTION OF THE DRAWINGS

FIG. 1 is an overhead view of a vehicle approaching a blind curve in a road;

FIG. 2 is an elevational view of vehicles on a road with a hill;

FIGS. 3A-3C illustrate a schematic of a method of processing and communication of a node of the present invention; and

FIG. 4 is a schematic of a node of the present invention.

### DETAILED DESCRIPTION OF THE INVENTION

The invention relates generally to a system for relaying information, such as road and rail safety information. This may occur due to communication between signaling devices (e.g., traffic safety lights) and/or receiving devices (collectively, “relaying devices”). The relaying devices may be stand-alone devices, may be embedded in vehicles, or may be associated with a means for communication (e.g. lights such as traffic safety lights, audio devices, audiovisual devices, etc.). Communication between relaying devices allows for propagating information, such as to vehicles in an area affected by a hazardous road condition.

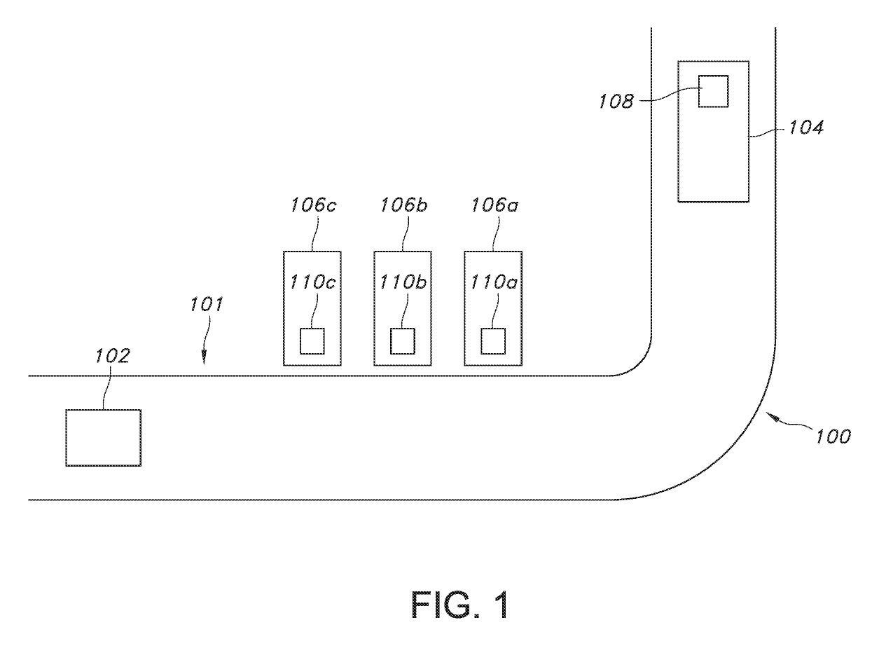

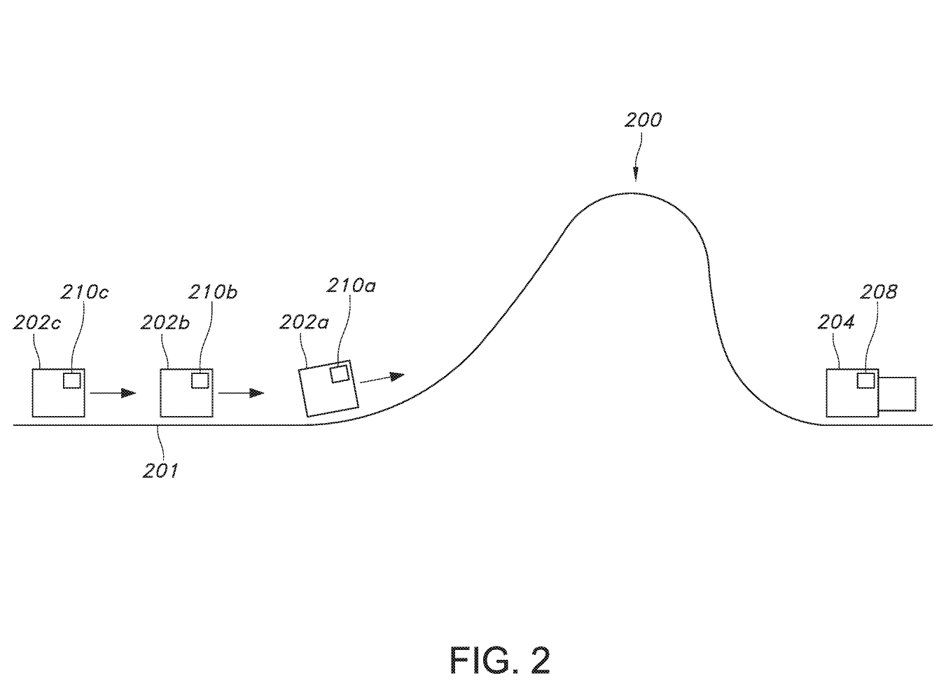

The problem exists, particularly in rural areas or any area where the view ahead is obstructed by curves, hills, or other obstructions, where motorists may be unaware of situations ahead of them (see, e.g. FIGS. 1 and 2). For example, a school bus may be unloading children on the other side of a sharp curve or blind hill and approaching cars are unable to see the school bus until it is quite close to the bus and the children. The invention allows the school bus to transmit, either directly or indirectly, a notification that it has stopped to signal lights and/or cars in the immediate area. This notification may be re-transmitted to other cars and/or signal lights that are not in range of the school bus, including cars and signal lights around curves and over hills to give motorists additional time to reduce speed or stop.

The invention may comprise a homogenous, non-fixed network of low powered electronic relaying devices in the form of embeddable nodes with wireless communications capabilities. The system may be implemented on a low power, embedded platform where power availability and wireless communication ranges are constrained. In one embodiment, the wireless communication between nodes of the system may be via radio waves (e.g. in the 2.4 GHz ISM band).

The nodes may be adapted to signal and intelligently relay safety events (e.g., an active school bus stop, a disabled vehicle or accident, an active rail crossing, etc.) to other nodes associated with vehicles or associated with signaling devices or other means of communication in a desired area of interest. These nodes may be embedded in vehicles such as school buses, cars, trucks, and trains and/or in infrastructure, such as dedicated signaling devices including warning lights or rail crossing systems.

The system may be capable of delivering notification of events to nodes that are not in range of the originating node and to nodes that do not have “line of sight” to the original node.

The system may utilize GPS and/or other means to determine location and/or the range from the originating node to determine if the notification should be relayed further.

In one embodiment, the invention may relate to fixed, flashing warning lights to be deployed near hazardous school bus stops that may receive signals from devices in school buses to signal that the bus is stopping. Such an embodiment may provide notification to motorists approaching the bus stop that children may be loading or unloading and allow for additional time to slow down or stop for the bus.

With reference to FIG. 1, a blind curve 100 in a road 101 illustrates a condition in which a driver of a first vehicle 102 is unable to visualize a second vehicle, such as a bus 104, around the curve 100. One or more indicators, such as hazard lights 106a, 106b, 106c, may be associated with the curve 100 in order to provide a notification means for notifying drivers of a hazardous road condition. The indicators may comprise any visual indication such as flashing lights, any audio indication such as a speaker or audible alarm, or any audio-visual display such as a monitor or other screen.

The bus 104 may be equipped with a node 108, which may be capable of sending and/or receiving information related to a hazardous condition or a predetermined condition which may necessitate caution. For example, the node 108 of the bus 104 may be adapted to send a signal when the bus is stopped and letting passengers on and/or off the bus. In this example, node 108 may be adapted to send or broadcast a signal that may be received by other nodes in the vicinity. For example, infrastructure elements such as hazard lights 106a, 106b, 106c each may be equipped with a node 110a, 110b, 110c, respectively. The node 108 of the bus 104 may be identical to the nodes 110a, 110b, 110c of the hazard lights 106a, 106b, 106c. In an alternate embodiment, the node 108 of the bus 104 may be adapted to broadcast signals only, while the nodes 110a, 110b, 110c of the hazard lights 106a, 106b, 106c, may be adapted to broadcast and/or receive signals.

In a further aspect of the invention, the nodes may be adapted to propagate a signal to allow for the signal to reach a node outside of the limits of the broadcasting proximity of the originating node. For example, the node 108 of the bus 104 may broadcast a signal indicating that the bus is stopped and allowing passengers on and off the bus. This signal may be received by the first node 110a associated with the first hazard light 106a, thereby causing the first hazard light to actuate a visual indication such as a flashing light. The indicator is not limited to a light or a flashing light at all, but rather element 106a may be adapted to emit any audible, visual, and/or audiovisual indication regarding the road condition that is not immediately visible to the driver of vehicle 102.

In the event that only the first node 110a is within range of the bus 104, then the signal from the node 108 associated with the bus 104 would be incapable of directly reaching the second and third nodes 110b, 110c, of the second and third hazard lights 106b, 106c. In order to further propagate the original signal, the first node 110a may be adapted to broadcast a signal related to or indicative of the signal originally broadcast from the node 108, so that second node 110b, which is in range of the first node 110a, but not the node 108 of the bus 104, may receive notification of the bus 104, indirectly through the first node 110a. Similarly, the third node 110c associated with the third hazard light 106c may be within transmitting range of either the first or second nodes 110a, 110b, but not the node 108 of the bus 104. In such a case, first and/or second nodes 110a, 110b may be capable of relaying a signal related to or indicative of the original signal from node 108, such that node 110c may receive notification of the bus 104, and thereby activate an indicator associated with hazard light 106c, such as a flashing light. In this manner, each of the hazard lights 106a, 106b, 106c may be activated, even if only a single one of the nodes 110a, 110b, 110c is within transmitting range of the node 108 of the bus 104.

The invention can additionally be applied to automobiles to directly receive notifications. For example, a further implementation of a network of nodes of the present invention is illustrated in FIG. 2. As can be seen, FIG. 2 illustrates a roadway 201 which includes a hill 200, preventing visualization of a damaged or disabled vehicle 204 by a driver of one or more mobile vehicles 202a, 202b, 202c. The disabled vehicle 204 may include an originating node 208, which is capable of broadcasting a signal warning. For example, the signal warning may be triggered in response to activation of the hazard lights of the disabled vehicle, or upon the disabled vehicle 204 engaging in a collision.

Additionally, one or more of mobile vehicles 202a, 202b, 202c may be equipped with a node 210a, 210b, 210c, as illustrated. Upon a first mobile vehicle 210a moving within range of an original signal broadcast by originating node 208 associated with disabled vehicle 204, first node 210a may receive said original signal. The first node 210a may be adapted to stimulate a response or notification in the first mobile vehicle 202a. For example, the original signal may cause the first node 210a to trigger the first mobile vehicle 202a to emit a visual, audible, and/or audiovisual notification to the driver of the first vehicle 202a. In one aspect, the notification may include a warning to the driver of the first vehicle 202a to begin slowing down the velocity of the first vehicle. Alternately, the original signal may trigger the driver of the first vehicle to take an alternate course to avoid the disabled vehicle 204.

The first node 210a may also be adapted to broadcast a signal related to or indicative of the original signal received from the originating node 208 of the damaged vehicle. In this manner, the first node 210a may propagate the notification that a disabled vehicle 204 is present or within the vicinity. For example, the first node 210a may broadcast a signal indicating the presence of the disabled vehicle 204 that may be received by the second node 210b associated with the second mobile vehicle 202b. Similarly, the second node 210b may be adapted to broadcast a signal related to or indicative of the original signal (i.e. a signal indicative of the disabled vehicle 204), which may be received by the third node 210c associated with the third mobile vehicle 202c. In this manner, each of the mobile vehicles 202a, 202b, 202c may be notified of the presence of the disabled vehicle 204, even if only a single one of the nodes 210a, 210b, 210c is within transmitting range of the originating node 208 of the disabled vehicle 204.

The invention may be applied to any number of situations that may benefit from notification of a condition requiring caution. For example, a train may be equipped with a node for broadcasting a signal indicating its approach to a rail crossing. Warning indicators, such as warning lights, located near the rail crossing may be equipped with nodes for receiving and/or propagating a signal indicating the train's approach, and for activating a warning in response to receiving the signal. Similarly, vehicles approaching the rail crossing may be equipped with nodes for receiving and/or propagating the signal indicating the train's approach, and for warning the driver of said vehicle of the approaching train.

In another embodiment, the system may be applied in a campus environment, in which any number of safety warnings may be propagated (e.g. fire, active shooter, chemical spill, etc.). Nodes capable of sending and/or receiving warning signals may be associated with any number of buildings or other locations related to the campus in order to propagate the signal.

In a further embodiment, the node may be integrated with or in communication with a vehicle's navigation system. For example, the vehicle's navigation system may use the system of the present invention to broadcast traffic congestion to other vehicles approaching the slowdown. This may occur in the event that the navigation system recognizes that the vehicle is on a major roadway and the vehicle's speed drops below a certain percentage of the posted speed for that road. This may be particularly useful in bad weather where visibility is constrained.

The nodes of the present invention may be independent of one another, in that each node may emit or receive signals without any knowledge, recognition, and/or identification of the presence of another node. The nodes may emit a broadcast (as opposed to a multicast) signal. This may simplify the process of propagating a signal across a network of nodes, as the signal need not be specified to target any particular node. Furthermore, any number of nodes may be used within the system, and any number of nodes may be added or removed from a system without affecting the ability of the remaining nodes from propagating a given signal.

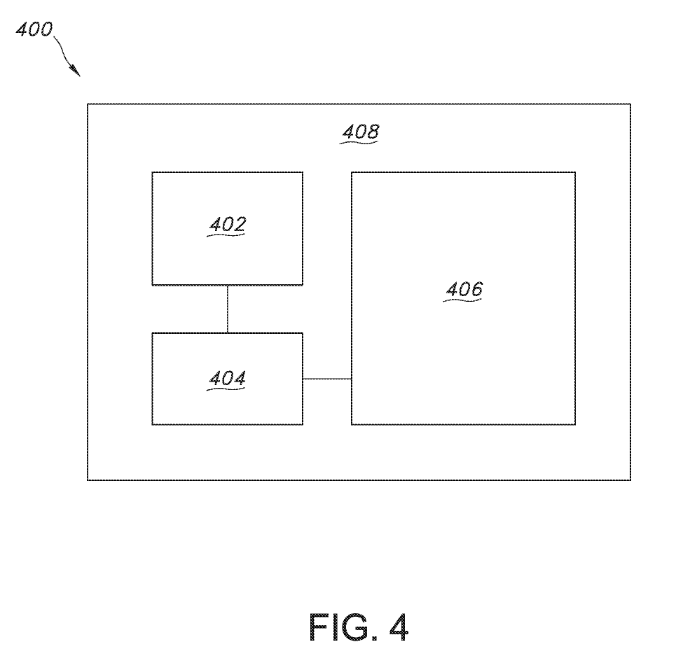

With reference to FIG. 4, each node may include a transceiver 402 for receiving and/or broadcasting a signal, a processor 404 for processing the signal, and an internal memory 406 for storing information. In one example, the transceiver may comprise a radio antenna. In one aspect, a housing 408 may surround each of these elements, or one or more elements may be mounted on an exterior of the housing.

The elements of a plurality of nodes may be adapted for practicing a communication protocol for sharing signaling information between relaying devices or nodes as outlined below.

The system may use a protocol for relaying notifications, node state information, node routing information and other housekeeping data between nodes. In one important aspect, the system of nodes implementing this protocol may utilize a method of recording the identity of nodes that have already relayed a particular signal or notification and transferring that record of nodes with the signal. This may create a sort of “traveling journal” which accompanies or is embedded within the broadcast signal. This may help prevent loops in the propagation of the signal, such that if a node receives a signal which includes or is accompanied by a record that said node has already broadcast said signal, the protocol may cause the node not to rebroadcast the signal.

In addition, a given node may maintain an “internal table” of recently seen or broadcast signals and/or notifications within a memory associated with the node. If a node receives a signal or notification that is already within the stored memory of the node, the protocol may cause the node not to rebroadcast the signal. This internal table may be used as another method of preventing the rebroadcasting of a given signal or notification.

The “traveling journal” method and the “internal table” method may be used independently of one another or in combination. When used in combination, this dual method of maintaining a “traveling journal” with the signal and a given node maintaining an “internal table” of recently broadcast signals provides a redundancy within the protocol which ensures that circular propagation of a signal is prevented and unnecessary noise is prevented from being broadcast within a given system of nodes.

In one aspect, the invention may use an encryption to ensure that malicious or false notifications are not propagated between nodes and that only authorized nodes participate in broadcasting, receiving, and rebroadcasting notifications. For example, the encryption scheme may include use of a 256 bit AES algorithm. This may allow devices that share an encryption key to interoperate.

The signals sent or received by the nodes may include a specific type of packet of information. A given packet may include a packet-type value, which may identify the type of packet being sent. For example, the signal may comprise a Discovery Beacon Packet, a Discovery Beacon Acknowledgement Packet, a Signal-On Broadcast Packet, an Extended Information Packet, or any other packet of information for communicating between nodes. The Discovery Beacon Packet may include a signal to any node receiving said packet that the sending node is in a state ready to receive information. The Discovery Beacon Acknowledgement Packet may include a signal to the sender of a Discovery Beacon Packet that the first has been received. The Signal-On Broadcast Packet may include a signal to any node that receives the packet that the sender wishes to activate warning signals in the vicinity. The Extended Information Packet may include information about the geographic location of the originating node of a Signal On Broadcast Packet.

In another aspect, the packet type may relate to the condition or situation being signaled. For instance, the packet type may be an Active School Bus Stop, an Active Railway Crossing, an Active Police Stop, a Stopped Traffic, a Traffic Accident, a Firefighter Event, a Public Safety Event, a Disabled Vehicle, an Ambulance, or a Work Zone packet type.

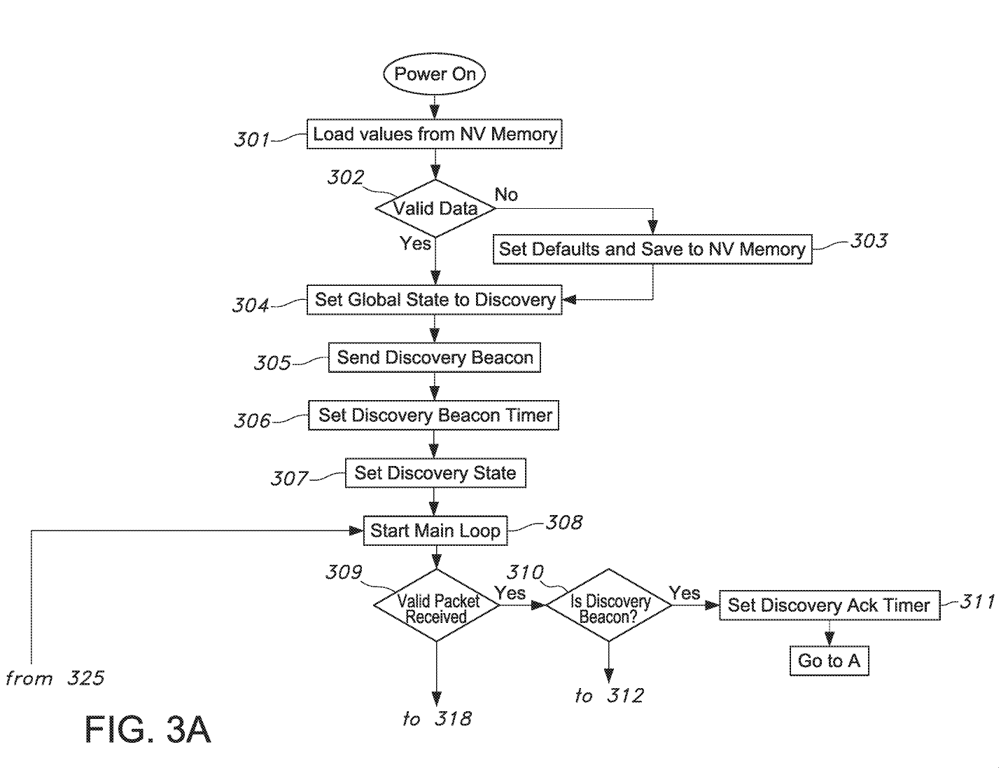

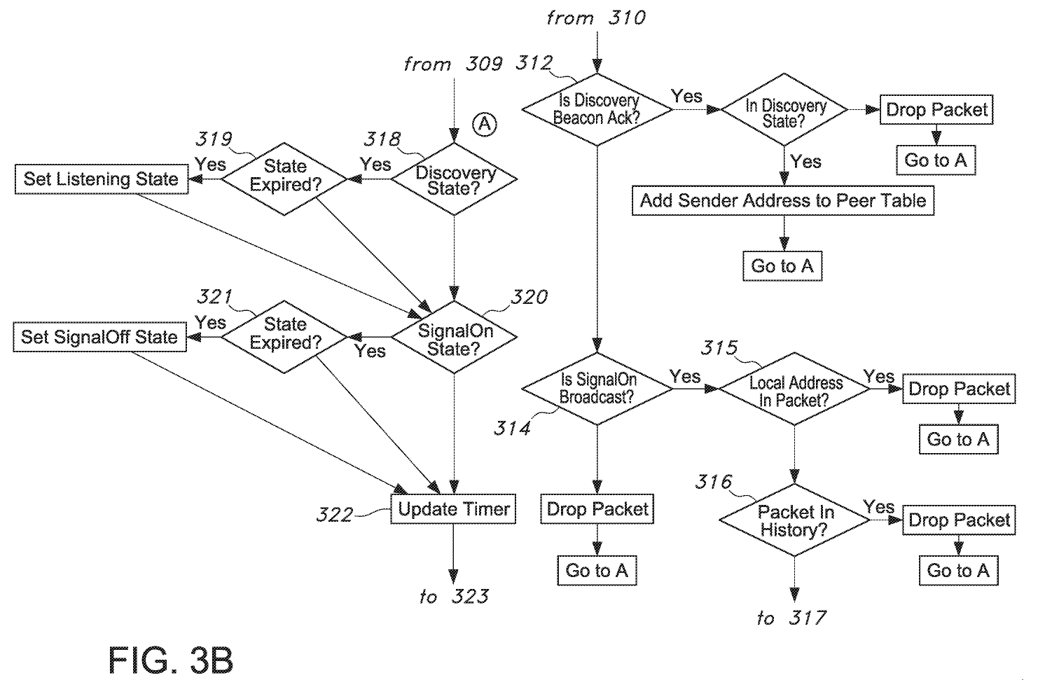

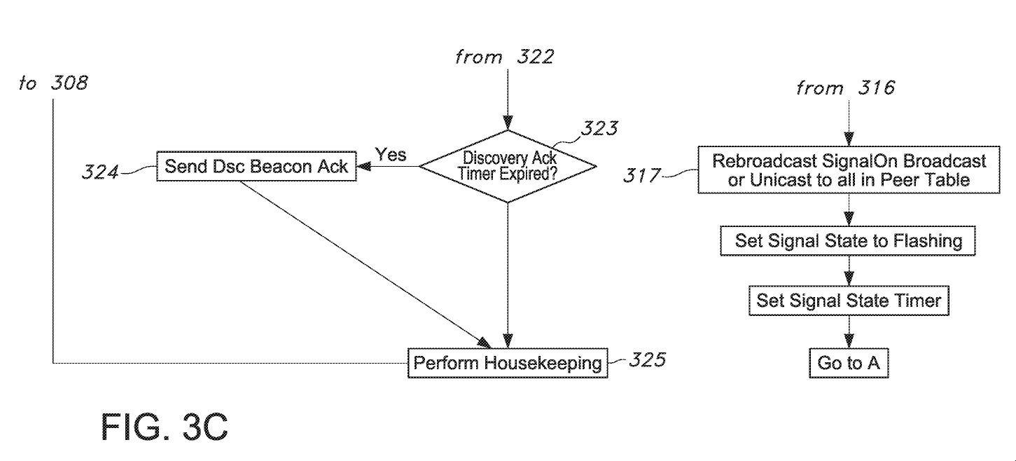

With further reference to FIG. 3, a protocol for communication between nodes, executed within a given node, is illustrated. Initially, when the power to a node is activated, the node may load parameter values from nonvolatile memory as indicated at step 301. This may include the node name, the hardware address, the encryption key to be used, a GPS location of the node, timeout values for broadcast states, and response and/or discovery acknowledgement windows.

A first field in the parameter structure may be a signature that tells the firmware if the structure contains valid values, as indicated at step 302. If the signature is valid, control may pass to step 304. If no valid parameters are found in nonvolatile memory, then default values may be set and the parameter structure may be saved to nonvolatile memory 303.

The global state value may be set to Discovery mode at step 304. A Discovery Beacon packet may be transmitted to the broadcast address at step 305. Step 306 may include setting a Discovery Beacon Timer to the parameter loaded from nonvolatile memory. For the duration of this interval, the node may accept Discovery Beacon

Acknowledgement packets from other nodes. The radio state value may be set to Discovery at step 307.

Upon completion of these initiation steps, the main loop through which the nodes enact the main communication protocol between nodes may begin at step 308. Initially within the main loop, at step 309, the radio receive buffer may be checked, to determine if a signal has been received by the node. In one embodiment, it is this step at which the buffer may be decrypted. If the decrypted data does not represent a valid packet received from another node, then control may pass to step 318, below.

If a valid packet is received by the node, then the packet is inspected. Step 310 evaluates whether or not a Discovery Beacon packet has been received. If the packet's type field indicates that it is not a Discovery Beacon packet (i.e. not a Discovery Beacon from another node), then control may be passed to step 312. If the packet inspected at step 310 is a Discovery Beacon packet, then the Discovery Acknowledgement Timer is set at step 311. This timer may be set to a random value between 0 and the Discovery Acknowledgement Window. At that point, control may pass to point A (beginning with step 318), at which point the evaluating node's own state and functions may be assessed.

If the packet inspected at step 310 is not a Discovery Beacon packet, then the node may inspect whether the packet is a Discovery Beacon Acknowledgement packet at step 312. If the packet is a Discovery Beacon Acknowledgement packet, then the protocol passes to step 313, at which the protocol determines whether the node is in the Discovery State. If so, then in one embodiment the sender address may added to a peer table so that the node recognizes the sender address as a peer node. At that point, the protocol may pass to point A.

If the node is determined not to be in the Discovery State at step 313, then the packet may be dropped or ignored, and the protocol may pass to point A.

In the event that the packet is determined not to be a Discovery Beacon Acknowledgement packet at step 312, the protocol passes to step 314, at which point the packet is evaluated as to whether or not it is a Signal On Broadcast packet. If the packet is not a Signal On Broadcast packet, then the packet is dropped, and the protocol may pass to point A.

If the packet is determined to be a Signal On Broadcast packet at step 314, then the packet is evaluated to determine if the packet contains the evaluating node's own local address at step 315. If the packet contains the evaluating node's own local address within the packet itself, then this indicates that the evaluating node has previously broadcast this packet, and therefore the packet is dropped and the protocol may pass to point A.

At step 316, the evaluating node may check the evaluating node's own internal memory for any record of having previously broadcast the packet. If so, then this indicates that a signal associated with the packet has already been broadcast from the evaluating node in the past, and therefore the packet may be dropped and the protocol may pass to point A.

In the event that the evaluating node's local address is not in the packet and evaluating node's internal memory does not include record of having previously sent the packet, then at step 317, the local node address may be added to the packet itself, such as within a “traveling journal” associated with the packet. In addition, the Signal On Broadcast packet may be rebroadcast by the evaluating node or may be unicasted to all nodes in the evaluating node's peer table. Also at step 317, the evaluating node's internal memory may be updated to include a record of having rebroadcast the packet.

Depending on the content of the packet, the evaluating node may also activate a signaling device with which the node is associated. For example, if the evaluating node is associated with a hazard light and if the packet indicated a condition that warrants activation of said hazard light (e.g. if the packet is an Active School Bus Stop packet), then said packet may cause the hazard light to flash. If the evaluating node is associated with a vehicle, then it may cause the driver of the vehicle to be notified of a road condition associated with a packet value associated with the packet. For example, an evaluating node associated with a vehicle may cause the driver to be notified of an active school bus stop, an active railway crossing, an active police stop, stopped traffic, a traffic accident, a firefighter event, a public safety event, a disabled vehicle, an ambulance, or a work zone. In addition, the evaluating node may set a Signal State timer, and control may be passed to point A. A Signal State Timer is an internal countdown clock representing the amount of time the node should remain in a certain state before returning to default ready state. For example a node with a signal light may turn on a warning light and set a Signal State Timer to time out after a period of time to indicate to the node that it is time to turn the signal light off and return to a default state.

Beginning at point A, the protocol contemplates the evaluating node conducting internal evaluations and/or adjusting internal settings related to the evaluating node itself. For example, at step 318, the node may determine whether or not the global state is in the Discovery State. The Discovery State may be a specified duration of time when the node is first powered on when it announces that it is on and listens for the presence of other nodes. If it is not in the Discovery State, then control may be passed to step 320. If the node is in the Discovery State, then the node may detect whether the Discovery State has expired at step 319. If the Discovery State has not expired, then control may pass to step 320. If the Discovery State has expired, then the global state may be set to a Listening State, and then control may be passed to step 320.

At step 320, the evaluating node may determine whether or not it is in the Signal On state. If the node is in the Signal On state, then node may determine whether or not the Signal State timer has expired at step 321. The Signal On State may be the state in which a node with a signal light is flashing its signal. If the Signal State timer has not expired, then control may pass to step 322. If the Signal State timer has expired, then the node may switch to a Signal Off state.

At step 322, the node may update the system timer. This system timer may be a global counter that keeps track of a “tick count” upon which other timing events may rely. For instance, the system timer may be a millisecond timer upon which other timers rely for timing purposes. For example, if a new Signal On Broadcast packet is set to be broadcast in 5 seconds, and the system timer is at 3491, then the broadcast timer may be set for 8491, namely 5000 milliseconds later. The system timer may be checked every time the protocol traverses the loop of FIG. 3. If the system timer is greater than 8491, then 5 seconds have passed and the node may send the Signal On Broadcast packet.

Upon updating the system timer, the node may determine whether or not its Discovery Acknowledgement Timer has expired at step 323. If said Discovery Acknowledgement Timer has expired, then the evaluating node may broadcast a Discovery Acknowledgement packet at step 324 for receipt by other nodes within the system.

If the Discovery Acknowledgement Timer has not expired, then the protocol may pass to step 325 for performance of housekeeping functions, which may include the sending of any Signal On Broadcast packets. The Signal On Broadcast packet sent at step 325 may include a broadcast in response to a stimulus other than receipt and rebroadcast of a valid Signal On Broadcast packet from another node. Instead, the Signal On Broadcast packet sent at step 325 may relate to a direct trigger to the evaluating node. For example, if the evaluating node is associated with a bus that has stopped and is loading and/or unloading passengers, the opening of the door may trigger the evaluating node to emit a Signal On Broadcast packet. Similarly, if the evaluating node is associated with a vehicle that has become disabled, then the act of the vehicle becoming disabled (e.g. a vehicle collision) may trigger the evaluating node to emit a Signal On Broadcast. In other words, the Signal On Broadcast packet that may be emitted at step 325 may be considered a packet which originates with the evaluating node, as opposed to one which is rebroadcast from a different node.

Subsequent to the housekeeping step 325, the protocol may pass back to step 308 to being the main loop again.

The processor(s) associated with the nodes of the present invention may be adapted for receiving programming instructions to enact the communication protocol between nodes. For example, the processor may be a low power ARM microcontroller.

While the disclosure presents certain embodiments to illustrate the inventive concepts, numerous modifications, alterations, and changes to the described embodiments are possible without departing from the sphere and scope of the present invention, as defined herein. For example, communication protocol is not limited to the specific order of communication steps described herein. Additionally, the nodes may be associated with any number of external devices, including lights, monitors, vehicles, buildings, signage, audio, visual, or audiovisual signals, communications devices such as phones, tablets, computers, Wifi routers, or any other element capable of communicating a signal received by the node. Accordingly, it is intended that the present disclosure not be limited to the described embodiments, but that it has the full scope defined by the language of the following claims, equivalents thereof, and that which is in the purview of the ordinarily skilled artisan upon examination of the disclosure.

1. A method for wirelessly propagating a signal, said method comprising the steps of:
broadcasting a signal packet from a first node, said signal packet including a first signal value indicating an identity of the first node;
receiving the signal packet including the first signal value in a second node, said second node within wireless range of the first node;
authenticating the signal packet in the second node; and
if authenticated, broadcasting the signal packet from the second node.

2. The method of claim 1, further including the step of receiving the signal packet in a third node, said third node within wireless range of the second node, but not within wireless range of the first node.

3. The method of claim 1, wherein the authenticating step comprises analyzing the signal packet to determine if the second node has previously broadcast the signal packet.

4. The method of claim 3, wherein the authenticating step further comprises analyzing an internal memory of the second node to determine if the second node has previously broadcast the signal packet.

5. The method of claim 1, wherein the authenticating step comprises analyzing an internal memory of the second node to determine if the second node has previously broadcast the signal packet.

6. The method of claim 1, wherein the authenticating step comprises utilizing an encryption key to determine whether the signal packet is received from a trusted source.

7. The method of claim 1, further including the step of triggering an output in response to the authenticating of the signal packet in the second node.

8. The method of claim 1, further including the step of adding a second signal value indicating an identity of the second node to the signal packet prior to broadcasting the signal packet from the second node.

9. A system of nodes adapted for communicating at least one signal packet, said system comprising:
a first node including a first controller in communication with a first internal memory and a first transceiver;
wherein the first transceiver is adapted to receive the signal packet at the first node;
wherein the first controller is adapted to authenticate the signal packet, including evaluating whether the signal packet includes a first value identifying the first node, thereby indicating that the first node has previously broadcast the signal packet; and
wherein, if the first controller determines that the signal packet does not include the first value identifying the first node, the first controller is further adapted to add the first value identifying the first node to the signal packet and to broadcast the signal packet including the first value via the first transceiver.

10. The system of claim 10, wherein the first controller is further adapted to authenticate the signal packet by comparing the signal packet to a list within the first internal memory of recent broadcasts emitted from the first transceiver in order to determine if the first node has previously broadcast the signal packet.

11. The system of claim 9, further including a second node including a second controller and a second transceiver;
wherein the second transceiver is adapted to receive the signal packet including the first value, from the first node; and
wherein the second controller is adapted to authenticate the signal packet including the first value, including evaluating whether the signal packet including the first value also includes a second value identifying the second node, thereby indicating that the second node has previously broadcast the signal packet; and
wherein, if the second controller determines that the signal packet including the first value does not include the second value identifying the second node, the second controller is further adapted to add the second value identifying the second node to the signal packet and to broadcast the signal packet including the first value and the second value via the second transceiver.

12. A method of signaling a condition requiring caution on a road, said method comprising:
providing a first node associated with a first vehicle, said first node adapted to broadcast a signal in response to the condition;
providing a second node adapted to receive the signal from the first node; and
triggering a warning indicator in a notification device in response to the second node receiving the signal from the first node.

13. The method of claim 12, wherein the first vehicle is a bus, and wherein the condition requiring caution comprises loading and/or unloading of passengers from the bus.

14. The method of claim 13, wherein the notification device comprises a warning light associated with the second node, and wherein the warning indicator comprises a flashing light.

15. The method of claim 12, wherein the second node is associated with a second vehicle.

16. The method of claim 15, wherein the warning indicator comprises an audio, visual, or audiovisual signal to a driver of the second vehicle relating to the condition.
